(19) United States
(12) Patent Application Publication
(10) Pub. No.: US 2016/0247359 A1
(43) Pub. Date: Aug. 25, 2016

(54) Wagering Platform with Options

(71) Applicant: METRIC GAMING LLC, Las Vegas, NV (US)

(72) Inventors: Martin De Knijff, Las Vegas, NV (US); Andrew Patterson, Las Vegas, NV (US)

(21) Appl. No.: 15/023,947

(22) PCT Filed: Sep. 23, 2014
(86) PCT No.: PCT/US2014/057045

§ 371 Date: Mar. 22, 2016

Related U.S. Application Data
(60) Provisional application No. 61/881,288, filed on Sep. 23, 2013.

(51) Int. Cl. G07F 17/32

(52) U.S. Cl. CPC G07F 17/3288; G07F 17/3267

(57) ABSTRACT

A wagering platform is described that generates one or more betting options and/or insurance to enable a bettor to modify his initial wager during a betting event such as, for example, a sporting event. The options can include, for example, allowing the bettor to double-down, to flip-flop, and/or to purchase bad-beat insurance. The platform can also include a locked-odds option to allow the bettor the option to place a wager at specified odds after the event has already started. Related apparatus, systems, techniques and articles are also described.

### CROSS-REFERENCE TO RELATED APPLICATION

This application claims the benefit of U.S. Provisional Patent Application No. 61/881,288, filed on Sep. 23, 2013, the contents of which are incorporated herein by reference in their entireties.

### TECHNICAL FIELD

The subject matter described herein relates to a wagering/betting platform, and particularly, for a platform for wagering/betting on one or more events, such as sporting events.

### BACKGROUND

In a traditional wagering platform, a bet or wager is placed on a future outcome such as the winner of a sporting event. Once the bet or wager is placed, it is final. Consequently, the bettor is unable to make any adjustments to the bet or wager, even as different events unfold, for example, before and/or during the event.

### SUMMARY

Variations of the present subject matter are directed to methods, systems, devices, and other articles of manufacture that are provided for wagering/betting. In some variations, methods, systems, devices, and other articles of manufacture are provided for wagering/betting on events, such as sporting events.

In some variations, a method for modifying a wager on a sporting event after initiation of the event is provided, the method includes receiving, by one or more processors, wager data representing a wager for a sporting event including a specified wager amount; generating, by one or more processors, betting option data for the received wager to modify the received wager by a predetermined multiple of the specified wager amount within a predetermined period of time after initiation of the event, the betting option includes a purchase price based at least in part on pre-event odds and the predetermined period of time; and transmitting, by one or more processors, the generated betting option data to be displayed to a user. In some variations, the purchase price is a percentage of the specified amount of the wager.

In some variations, the method can further include generating, by one or more processors, further betting option data including an additional option purchase price to allow the wager to be switched to a different team or player of the sporting event based at least in part on the pre-event odds and the predetermined period of time.

In some variations, the method can further include generating, by one or more processors, protection data based on one or more triggers for the wager to provide a refund if the one or more triggers occur during the sporting event if the wager loses at the end of the event, the protection data includes a protection purchase price based at least in part on the one or more triggers. In some variations, the protection data further includes one or more terms that are based at least in part on a type of the sporting event and/or a margin.

In some variations, a method for modifying a wager on a sporting event after initiation of the event is provided. The method can include receiving, by one or more processors, wager data representing a first wager on a first outcome of a sporting event for a specified amount; generating, by one or more processors, betting option data including a determined option purchase price to allow the first wager to be switched to a second outcome different from the first outcome; and transmitting, by one or more processors, the generated betting option data to be displayed to a user. In some variations, the purchase price is a percentage of the specified amount of the wager. The second outcome can include a different team and/or player in some variations.

In some variations, a method for protecting a wager on a sporting event after initiation of the sporting event is provided. The method can include generating, by one or more processors, wager protection data for the sporting event including a protection purchase price based on one or more triggers representing one or more in-game outcomes of the sporting event; monitoring, by one or more processors, data representing the sporting event for the occurrence of each of the one or more triggers; wherein when all of the triggers have occurred during the sporting event, generating, by one or more processors, a refund data if a final outcome of the sporting event is contrary to an initial wager. In some variations, the protection purchase price is a percentage of a specified amount of the initial wager.

A wagering system is also provided in some variations. The system can include providing at least one server, the server having computer instructions operating thereon to perform a method for modifying a wager on a sporting event after initiation of the event, the method comprising: receiving, by one or more processors, wager data representing a wager for the sporting event for a specified amount; generating, by one or more processors, betting option data for the received wager to modify the wager by a predetermined multiple from the wager within a predetermined period of time after initiation of the event, the betting option includes a purchase price based at least in part on pre-event odds and the predetermined period of time; and transmitting, by one or more processors, the generated betting option data to be displayed to a user. In some variations, the purchase price is a percentage of the specified amount of the wager.

In some variations, the system can further include generating, by one or more processors, further betting option data including an additional option purchase price to allow the wager to be switched to a different team or player of the sporting event based at least in part on the pre-event odds and the predetermined period of time.

In some variations, the can further include generating, by one or more processors, protection data based on one or more triggers for the wager to provide a refund if the one or more triggers occur during the sporting event if the wager loses at the end of the event, the protection data includes a protection purchase price based at least in part on the one or more triggers. In some variations, the protection data further includes one or more terms that are based at least in part on a type of the sporting event and/or a margin.

In some variations, the current subject matter provides a non-transitory computer readable media having computer instructions/code provided therein for enabling a method for modifying a wager on a sporting event after initiation of the event, the method includes: receiving, by one or more processors, wager data representing a first wager on a first outcome of a sporting event for a specified amount; generating, by one or more processors, betting option data including a determined option purchase price to allow the first wager to be switched to a second outcome different from the first outcome; and transmitting, by one or more processors, the generated betting option data to be displayed to a user. In some variations, the purchase price is a percentage of the specified amount of the wager.

In some variations, the non-transitory computer readable media further includes instructions for generating, by one or more processors, further betting option data including a further option purchase price to allow the wager to be switched to a different team or player, and transmitting, by one or more processors, the further betting option data to be displayed to the user.

In some variations, the non-transitory computer readable media further includes instructions for generating, by one or more processors, protection data based on one or more triggers for the wager to provide a refund if the one or more triggers occur during the sporting event if the wager loses at the end of the event, the protection data includes a protection purchase price based at least in part on the one or more triggers. In some variations, the protection data further includes one or more terms that are based at least in part on a type of the sporting event and/or a margin.

The current subject matter also provides, in some variations, a computer-implemented method for wagering on a sporting event, the method includes: receiving, by one or more processors before a start of the sporting event, in-event wager data representing a wager for the sporting event including a specified wager amount and a time period during which the wager can be exercised, the time period begins after the start of the sporting event; generating, by one or more processors, betting option data for the received in-event wager based at least in part on pre-event odds, the specified wager amount, and the time period, the betting option data includes an option purchase price, which if paid, allows the wager to be exercised during the time period; and transmitting, by one or more processors, the generated betting option data to be displayed to a user. In some variations, the betting option data is generated based also at least in part on whether the user had placed a pre-event wager prior to the start of the event.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many advantages. For example, by providing the bettor with one or more options to alter his wager, the bettor can adjust the wager based on (for example) one or more actions, events, or circumstances that occur before and/or during the sporting event. This can provide a greater payout or a reduced risk for the bettor. This can also provide a more interactive, exciting, and enjoyable betting/wagering experience for the bettor.

### BRIEF DESCRIPTION OF THE FIGURE

FIG. 1 is a timing diagram illustrating some of the features of the current subject matter;

FIG. 2 is a diagrammatic view of a wagering platform in accordance with a variation of the current subject matter;

FIG. 3 is a process flow diagram showing features in accordance with some variations of the current subject matter; and

FIG. 4 is another process flow diagram showing features in accordance with some variations of the current subject matter.

### DESCRIPTION

The current subject matter provides a wagering platform which provides one or more options to the bettor before and/or during the wagering event such as, for example, a sporting event.

Double-Down Option

In some variations, the current subject matter provides a platform, a gaming system, and method, for example, in which an individual (bettor), having placed a wager/bet (terms used interchangeably throughout) has the option of increasing his wager by a predetermined multiple (for example) after a predetermined period of time after the beginning of the sporting event. For example, the bettor can have the option to double his wager after the first quarter, or half (for example) (referred to as the “Double-Down Option”). It should be noted that other options such as, for example, triple-down, or any other multiples or wagers are also available in some variations.

In some variations, this option may be exercised at any time before a pre-defined point in a sporting event (for example), and allows the bettor to double his original bet (or other multiple thereof) on the sporting event at the same betting line as the original bet. In some variations, this option would be for a predetermined purchase price, to which, in some variations, this option purchase price is nonrefundable.

For example, a bettor places $110 on New England −3 (−110) to win $100. In some embodiments, the bettor is offered the Double-Down Option at a certain price ($X), with such option expiring at the end of the first quarter. The bettor may purchase the option for $X, and $X is permanently deducted from an account associated with the bettor. In return, the bettor now has the option—at any point before the end of the first quarter—to double his original wager. If the bettor declines to exercise the option (e.g., New England falls behind 14-0 in the first quarter), the bettor's original $110 wager remains as is. If, on the other hand, the bettor exercises the option (e.g., New England takes a 14-0 lead in the first quarter), an additional $110 would be deducted from the bettor's account, and the bettor would now have $220 on New England −3 (−110) to win $200.

In some variations, the option purchase price may be expressed as a percentage of the original bet. In some variations, the price/percentage of the original bet may be determined in accordance with a complex algorithm based on, for example, an in-depth analysis of historical or other data.

In some variations, the “Double-Down” option can allow the bettor to increase the bet size at the same odds that were available when the pre-game (initial) bet was placed.

In some variations, the option purchase price (the price the bettor pays to have, for example, the “Double-Down Option” available) can be determined based on one or more factors including, for example, (i) the pre-game odds at the time the original bet is selected; (ii) the team/player selected; (iii) the multiple at which the bet can be increased; and (iv) the option exercise period (all as pre-set or dictated by the bettor). In some variations, the option purchase price can be processed based on one or more special algorithms (e.g., based on quantitative analysis of historical and/or other sports data), for example, internally on a specially configured betting server, or communicated externally via APIs (Application Programming Interface) to a third party (which processes the information and sends back the option prices also via an API).

In some variations, if the bettor purchases the option, the option price can be deducted from the player's wagering account. In some variations, the bettor can purchase the option through a local agent, for example, when placing his/her initial bet.

In some variations, the platform can be configured to allow the bettor to select/adjust one or more parameters of the “Double-Down” option including, for example, the multiple by which the bet can be increased and how long into the match the option remains available for exercise. In some variations, one or more of the parameters of the option are pre-set.

The Flip-Flop Option

In some variations, a “Flip-Flop” or “Switch” option can be provided to a bettor to allow the bettor to switch his original bet to the opposing team (for example) at the same betting line as the original bet (e.g., at the same odds that were available on that team/player when the pre-game bet was placed). In some variations, this option may be exercised at any time, for example, before a pre-defined point in the event (e.g., quarter, half, etc. of a sporting event). A purchase price for the option can be nonrefundable in some variations.

For example, a better places $110 on New England −3 (−110) over Baltimore to win $100. The bettor can be offered the Flip-Flop/Switch Option at a certain price ($Y), with such option expiring at the end of the first quarter (for example). The bettor can purchase the option for $Y, and $Y is permanently deducted from an account associated with the bettor. In return for this purchased option, the bettor now has the option—at any point before the end of the first quarter (for example)—to switch his original wager/bet to $110 on Baltimore +3 to win $100. According to some variations, if the bettor declines to exercise that option (e.g., New England takes a 14-0 lead in the first quarter), the bettor's original $110 wager remains as is. According to some variations, if, on the other hand, the bettor exercises the option (e.g., Baltimore takes a 14-0 lead in the first quarter), the bettor's original wager would be canceled, and he would now have $110 on Baltimore +3 (−110) to win $100.

In some variations, $Y can be expressed as a percentage of the original bet. In some variations, $Y can be determined based one or more factors including, for example (i) the pre-game odds at the time the original bet is selected; (ii) the team/player selected; and (iii) the option exercise period (as pre-set or dictated by the bettor). In some variations, the option purchase price can be processed based on one or more special algorithm (e.g., based on quantitative analysis of historical and/or other sports data), for example, internally on a specially configured betting server, or communicated externally via APIs (Application Programming Interface) to a third party (which processes the information and sends back the option prices also via an API).

In some variations, the platform can be configured to allow the bettor to select/adjust one or more parameters of the “Flip-Flop” option including, for example, how long into the match the option remains available for exercise. In some variations, one or more of the parameters of the option are pre-set.

The Locked-Odds Option

In some variations, no pre-event wager is required. For example, the platform may provide the bettor with a “Locked-Odds Option” to allow the bettor to place a wager on a specified team/player—at fixed, specified odds—after the match has already started. The bettor can select one or more of, for example, the wager, the wager amount, and the length of the option exercise period (i.e., how long into the event the option remains available for exercise). In some variations, one or more of these parameters can be pre-set. The “Locked-Odds” option purchase price can be determined based on one or more factors such as (i) the pre-game odds; (ii) the team/player selected; (iii) the specified wager amount; and (iv) the option exercise period (as pre-set or dictated by the bettor). This information can be processed internally by the server, or communicated externally via APIs to a third party (which processes the information and sends back the option prices also via an API), in accordance with a special algorithm (e.g., based on quantitative analysis of historical and/or other sports data).

Bad-Beat Protection

In some variations, “Bad-Beat Protection” can be provided to a bettor to allow him to purchase “protection” on his wager/bet. In some variations, the terms of the protection can vary depending on one or more factors such as, for example, the sport and/or line on which the bettor is betting. For example, if the bettor's wager is winning by a certain point in the game and/or by a certain margin (for example), and the bettor has purchased Bad-Beat Protection, the bettor will be entitled to a partial or complete refund if the wager thereafter ends up losing.

In some variations, the platform can be configured to allow the bettor to customize one or more aspects of the protection. For example, the bettor can select and/or adjust one or more variables (X, Y, Z) such as: “If the bettor's team/player is winning by X points/goals/runs with Y minutes/innings remaining in the match, then if the bettor's wager still ends up losing, the better will receive a Z % refund of his/her wager.” In some variations, one or more of these variables (X, Y, Z) can be pre-set.

For example, in a football game, the bettor wagers on New England −2.5, meaning New England must win the game by 3 or more for the wager to be successful. At one minute before the end of the game, New England is up by 3, so had the game ended then, the bettor would have won his wager. If, however, the opponent scores a touchdown during the final minute of the game, the bettor would lose his bet. On the other hand, if the bettor had purchased the Bad-Beat Protection, for example, as discussed above, then the bettor would be entitled to the winnings he would have had at the time of the insurance purchase, or at least a full or partial refund of the original wager.

In some variations, the protection purchase price can be based on one or more factors including, for example, (i) the pre-game odds at the time the protection is purchased; (ii) the team/player selected; and (iii) the specific terms of the protection (as pre-set or specified by the better). In some variations, the protection purchase price can be processed based on one or more special algorithms (e.g., based on quantitative analysis of historical and/or other sports data), for example, internally on a specially configured betting server, or communicated externally via APIs (Application Programming Interface) to a third party (which processes the information and sends back the option prices also via an API).

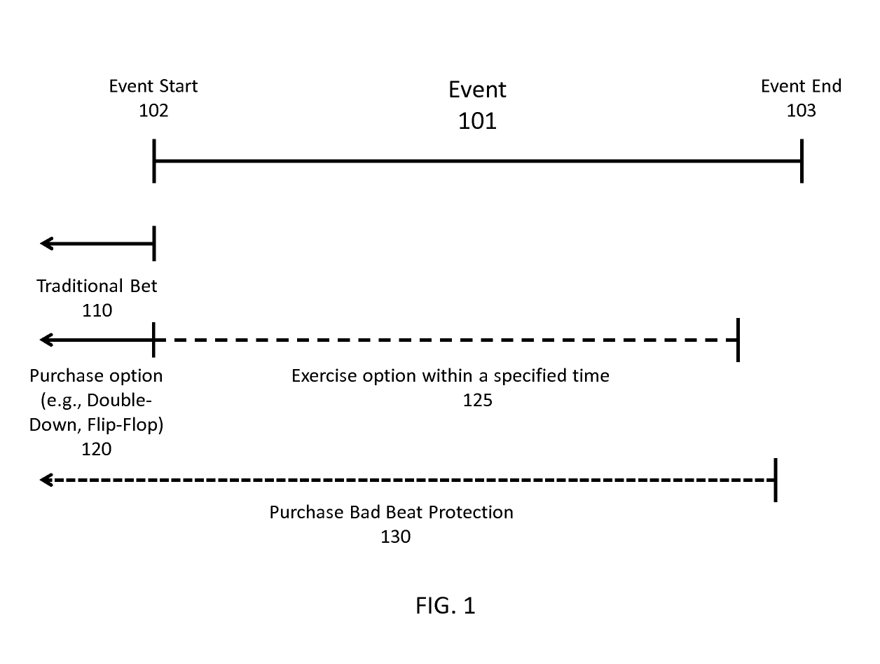

FIG. 1 is a timing diagram showing some of the features of the current subject matter. As shown, the wagering platform of the current subject matter can be configured to enable a bettor to place a wager with respect to an event 101 (e.g., a live sporting event), which starts at time 102, and ends at time 103. Prior to the event start 102, a traditional bet can be placed with respect to the event's outcome at event end 103. Prior to the event start, one or more options 120 such as the “Double-Down” and/or “Flip-Flop” options discussed herein can be purchased by the bettor for the event 101. If one or more options 120 are purchased, then the bettor can choose to exercise those options within the specified time of the respective option (e.g., before the end of the first quarter or half). The wagering platform can also be configured to provide “Bad Beat Protection” as discussed herein to be purchased by the bettor before the event end 103.

As can be seen in FIG. 1, a traditional bet only requires action before the start of the event, and is dependent only on the ultimate outcome of the event at the end of the event. By providing additional options (e.g., double-down, flip-flop, locked-odds, and bad beat protection), the current subject matter allows the bettor to, for example, adjust the wager based on (for example) one or more actions, events, or circumstances that occur before and/or during the sporting event. This can provide a greater payout or a reduced risk for the bettor. By providing in-event wager options, the current subject matter can provide a more interactive, exciting, and enjoyable betting/wagering experience for the bettor.

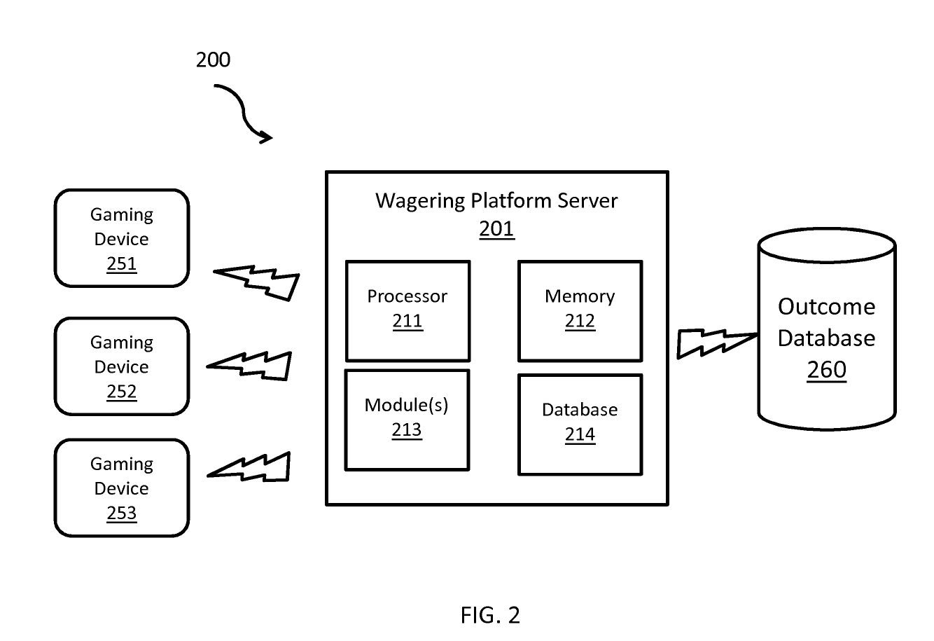

FIG. 2 shows an example of a computer-implemented system in accordance with the current subject matter. Here, the wagering platform/system 200 includes a wagering platform server 201 in communication (e.g., through APIs) with one or more gaming device 251-253 and an outcome database 260. The server 201 includes one or more processors 211, memories 212, modules 213, and databases 214. The one or more modules 213 can be configured with instructions that when executed by the one or more processors 211, performs one or more features of the wagering platform discussed herein including, for example, one or more betting options and/or protection. The outcome database 260 can be configured to store the outcomes of various gaming events on which bets can be/have been placed. In some variations, the outcome database 260 is implemented within database 214 of the wagering platform server 201.

In some variations, the gaming devices 251-253 can be, for example, smart phones, tablets, PCs, or dedicated gaming machines. These devices preferably each include a display and an input device. These devices can be configured to generate one or more betting data based on input by the bettors, and send the betting data to the server 201. These devices can also be configured to receive one or more gaming data and/or betting options from the server 201, to be displayed to the bettors via, for example, a user interface.

In some variations, one or more of the gaming devices can be configured to display that an option exercise button (or other suitable graphical representation) visible, for example, in the bettor's account next to the pending wager to which the purchased option is attached. The option exercise button can be configured to be removed from display after, for example, the option exercise period has expired. If the exercise button is pressed during the exercise period, the bettor's pending wager will be adjusted accordingly (e.g., doubled, flip-flopped), or in the case of the “Locked-Odds” option, the appropriate wager will be added. Upon purchase, the option and/or protection purchase price(s) can be deducted from the bettor's wagering account, for example, based on bettor account data stored on the server 201.

In some variations, no option may be purchased unless the bettor has sufficient funds in his or her wagering account to purchase the option/protection and to cover any additional funds associated with the exercise of the option (e.g., for the Double-Down and/or the Locked-Odds Options).

In some variations, one of more of the gaming devices can be configured to be operated by a local agent such as a teller, for example, at a counter or kiosk in a betting shop (or casino). The gaming devices can be operationally connected to a printer to print a wager ticket, for example, when a bettor places an initial bet. The wager ticket can be provided with information on one or more of the options and/or protection discussed herein generated by the server, to allow the bettor to purchase them.

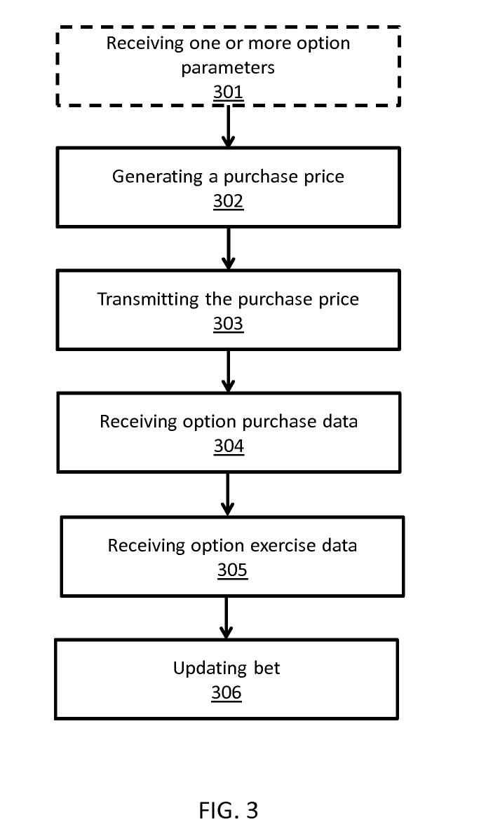

FIG. 3 illustrates a process flow of an example of the wagering platform in accordance with the current subject matter. In some variations, the bettor can customize one or more options parameters (e.g., the multiple by which the bet can be increased, the option exercise period) via, for example, the gaming device, teller, or an automated kiosk. These options parameters are transmitted and received by the server at 301. In some variations, one or more options parameters can be pre-set.

At 302, the server generates a purchase price based on, for example, the options parameters selected by the bettor and/or other parameters such as the pre-game odds; the team/player selected; or a combination thereof. This can be done, for example, based on a special algorithm based on quantitative analysis of historical and/or other sports data).

At 303, the purchase price is transmitted to the gaming device to be displayed to the bettor. If the bettor purchases the option, the purchase price can be deducted from the bettor's account, or the bettor can pay the purchase price via, for example, a teller or an automated kiosk. Once the user purchases the option, option purchase data is generated and transmitted to the server, which is received at 304.

If the option is purchased, the user can exercise the option within the option period (i.e., before the end of the option exercise period), for example, via the gaming device, teller, or automated kiosk. In that case, option exercise data is generated, and transmitted to the server, which is received by the server at 305. Upon receipt, the server updates the betting information associated with the bet (e.g., double the initial bet, flip-flop, etc.) at 306. The server can deduct the appropriate costs from the bettor's account, or the bettor can pay via, for example, the teller, or automated kiosk.

In some variations, the gaming device can display an option icon to show the bettor that the option is available (during the option period). If the option period expires and the user did not exercise the option, the server can generate and transmit a command to the gaming device to alert the bettor, for example, by graying or removing the option icon. In some variations, the option icon can include a clock showing how much time remains in the option period and/or generate a message to alert the bettor near the end of the option period.

In some variations, upon purchase of the option, the bettor can be provided with a wagering ticket that contains, for example, a barcode or other identification means with the details of the bettor's option encoded. The bettor can exercise the option by inserting the ticket into an automated kiosk, or via a teller during the specified option period. In some variations, the option period is encoded in the wager ticket barcode, such that any attempt to exercise the option after the deadline would be ineffective. If the option is exercised within the exercise period, the kiosk or teller can accept the ticket, and require the bettor to pay any required funds (e.g., the difference between the new wager amount and the original wager amount). Once paid, the kiosk or teller can generate a new wagering ticket representing the new wager (e.g., new wager amount, team/player, etc.).

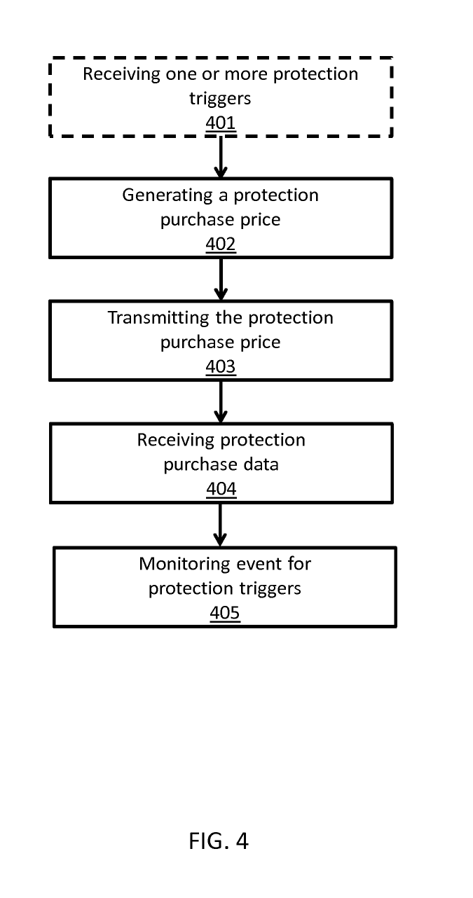

FIG. 4 illustrates a process flow of an example of Bad-Beat Protection of the current subject matter. At 401, the bettor can customize (e.g., select/adjust) one or more triggers, which if occur within the event, the bettor receives a full or partial wager refund. For example, if a team/player is winning by a certain number of points/goals/runs within a certain number of minutes/innings remaining in the event, and the original bet still ends up losing, the bettor will receive a refund (e.g., full or partial) of the wager. In some variations, one or more of the triggers can be pre-set. In some variations, the bettor can further purchase protection against any number of contingencies to trigger a full or partial wager refund, such as, for example, weather conditions, injuries, player ejections, etc. (one or more of which can also be pre-set). The bettor can customize and submit the triggers using, for example, a gaming device, an automatic kiosk, or via a teller.

At 402, the server generates a protection purchase price based on one or more of, for example, the pre-game odds; the team/player; and the specific terms of the protection (e.g., pre-set and/or specified by the bettor) using, for example, a special algorithm based on quantitative analysis of historical and/or other sports data. The protection purchase price is transmitted to the gaming device, kiosk, or teller at 403. If the bettor purchases the protection, protection purchase data is generated and transmitted, which is received by the server at 404. The server then monitors the event to see whether the terms of the protection are met, and if met, determine the appropriate refund at 405.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1-26. (canceled)

27. A computer-implemented method for modifying a wager on a sporting event after initiation of the event, the method comprising:
receiving, by one or more processors, wager data representing a wager for a sporting event including a specified wager amount;
generating, by one or more processors, betting option data for the received wager to modify the received wager by a predetermined multiple of the specified wager amount within a predetermined period of time after initiation of the event, the betting option includes a purchase price based at least in part on pre-event odds and the predetermined period of time; and
transmitting, by one or more processors, the generated betting option data to be displayed to a user.

28. The computer-implemented method according to claim 27, wherein the purchase price is a percentage of the specified amount of the wager.

29. The computer-implemented method according to claim 27, further comprising generating, by one or more processors, further betting option data including an additional option purchase price to allow the wager to be switched to a different team and/or player of the sporting event based at least in part on the pre-event odds and the predetermined period of time.

30. The computer-implemented method according to claim 27, further comprising generating, by one or more processors, protection data based on one or more triggers for the wager to provide a refund if the one or more triggers occur during the sporting event if the wager loses at the end of the event, the protection data includes a protection purchase price based at least in part on the one or more triggers.

31. The computer-implemented method according to claim 27, further comprising:
receiving, by one or more processors, first wager data representing a first wager on a first outcome of a sporting event for a specified amount;
generating, by one or more processors, bet-switching option data including a determined bet-switching option purchase price to allow the first wager to be switched to a second outcome different from the first outcome; and
transmitting, by one or more processors, the generated bet-switching option data to be displayed to a user.

32. The computer-implemented method according to claim 30, wherein the one or more triggers representing one or more in-game outcomes of the sporting event; the method further comprising monitoring, by one or more processors, data representing the sporting event for the occurrence of each of the one or more triggers; and generating, by one or more processors, a refund data if a final outcome of the sporting event is contrary to an initial wager when all of the triggers have occurred during the sporting event.

33. The computer-implemented method according to claim 27, further comprising:
receiving, by one or more processors before a start of the sporting event, in-event wager data representing a wager for the sporting event including a specified wager amount and a time period during which the wager can be exercised, the time period begins after the start of the sporting event;
generating, by one or more processors, further betting option data for the received in-event wager based at least in part on pre-event odds, the specified wager amount, and the time period, the further betting option data includes an option purchase price, which if paid, allows the wager to be exercised during the time period; and
transmitting, by one or more processors, the generated further betting option data to be displayed to a user.

34. The computer-implemented method according to claim 33, wherein the betting option data is generated based also at least in part on whether the user had placed a pre-event wager prior to the start of the event.

35. A wagering system comprising:
providing at least one server, the server having computer instructions operating thereon to perform a method for modifying a wager on a sporting event after initiation of the event, the method comprising:
receiving, by one or more processors, wager data representing a wager for the sporting event for a specified amount;
generating, by one or more processors, betting option data for the received wager to modify the wager by a predetermined multiple from the wager within a predetermined period of time after initiation of the event, the betting option includes a purchase price based at least in part on pre-event odds and the predetermined period of time; and
transmitting, by one or more processors, the generated betting option data to be displayed to a user.

36. The system according to claim 35, wherein the purchase price is a percentage of the specified amount of the wager.

37. The system to claim 35, further comprising generating, by one or more processors, further betting option data including an additional option purchase price to allow the wager to be switched to a different team or player of the sporting event based at least in part on the pre-event odds and the predetermined period of time.

38. The system according to claim 35, further comprising generating, by one or more processors, protection data based on one or more triggers for the wager to provide a refund if the one or more triggers occur during the sporting event if the wager loses at the end of the event, the protection data includes a protection purchase price based at least in part on the one or more triggers.

39. The system according to claim 38, wherein the protection data further includes one or more terms that are based at least in part on a type of the sporting event and/or a margin.

40. The system according to claim 35, wherein the wager data includes a time period during which the wager can be exercised, the time period begins after the start of the sporting event; the betting option data is generated based at least in part on the time period.

41. The system according to claim 40, wherein the betting option data is generated based also at least in part on whether the user had placed a pre-event wager prior to the start of the event.

42. A non-transitory computer readable media having computer instructions/code provided therein for enabling a method for modifying a wager on a sporting event after initiation of the event, the method comprising:
receiving, by one or more processors, wager data representing a first wager on a first outcome of a sporting event for a specified amount;
generating, by one or more processors, betting option data including a determined option purchase price to allow the first wager to be switched to a second outcome different from the first outcome; and
transmitting, by one or more processors, the generated betting option data to be displayed to a user.

43. The non-transitory computer readable media according to claim 42, further comprising generating, by one or more processors, further betting option data including a further option purchase price to allow the wager to be switched to a different team or player, and transmitting, by one or more processors, the further betting option data to be displayed to the user.

44. The non-transitory computer readable media according to claim 42, further comprising generating, by one or more processors, protection data based on one or more triggers for the wager to provide a refund if the one or more triggers occur during the sporting event if the wager loses at the end of the event, the protection data includes a protection purchase price based at least in part on the one or more triggers.

45. The non-transitory computer readable media according to claim 44, wherein the wager data includes a time period during which the wager can be exercised, the time period begins after the start of the sporting event; the betting option data is generated based at least in part on the time period.

46. The non-transitory computer readable media according to claim 44, wherein the betting option data is generated based also at least in part on whether the user had placed a pre-event wager prior to the start of the event.
